(19) United States
(12) Patent Application Publication
(10) Pub. No.: US 2005/0219553 A1
(43) Pub. Date: Oct. 6, 2005

(54) Monitoring apparatus

(76) Inventors: Patrick Vincent Kelly, Cork (IE); Liam Kehoe, Cork (IE)

Correspondence Address: JACOBSON HOLMAN PLLC, 400 SEVENTH STREET N.W., SUITE 600, WASHINGTON, DC, 20004, US

(21) Appl. No.: 11/042,148

(22) Filed: Jan. 26, 2005

Related U.S. Application Data
(63) Continuation of application No. PCT/IE03/00109, filed on Jul. 31, 2003.

(51) Int. Cl. G01B 11/24

(52) U.S. Cl. 356/605

(57) ABSTRACT

A monitoring apparatus has a first illumination path (LS1, L1, RG1, C5, L3, C1, 27) for structured illumination, a second illumination path (LS2, L2, C2, C5, L3, C1, 27) for uniform illumination, and a third illumination path (LS3, RG2, C3, C2, C5, L3, C1, 27) for off-axis laser illumination. All illumination is focused onto the back focal plane of the objective, that from the third path being off-axis for out-of-plane Moiré analysis. The controller has a range of programmed modes of operation for one or combinations of in-plane Moiré, out-of-plane Moiré, and image correlation analysis.

### FIELD OF THE INVENTION

The invention relates to an optical apparatus for the determination of deformation, strain, mechanical movement, thermal expansion, or dimensions, of a material or a material structure.

### PRIOR ART DISCUSSION

A requirement exists for advanced analytical methods and apparatus for direct thermomechanical strain measurement in microelectronic, optoelectronic and micro-systems and their components. It is preferable that non-contact or non-destructive methods and apparatus are used for strain measurement.

Examples of the strain measurement requirements generic to micro-engineered products include:
(a) Microelectronic devices: Deformation maps of both out of plane and in-plane local deformation of advanced large-area single-chip packages, as well as in-plane deformation maps of cross-sectioned integrated circuit packages.
(b) Electronic hybrids and components: Deformation maps of both out of plane and in-plane local deformation of multi-chip module (MCM) components.
(c) Microsystems: Measurement of strain and deformation in sensors and microsystem components, as well as in the packages for these devices and in the components for and complete micro-electro-mechanical-systems (MEMS) and micro-opto-electro-mechanical-systems (MOEMs).

Strain is defined as the fractional deformation resulting from a stress, and so deformation measurement is required to measure strain directly. Other indirect methods of strain measurement may be employed based on the measurement of a strain induced effect, for example, the use of electronic integrated circuits whose parameters or functionality are strain dependent, to measure strain in an integrated circuit package. Excessive thermomechanical deformation strain in microsystems or microelectronic packages is known to lead to the development of failure mechanisms which reduce the mean time to failure, or the useful lifetime, of these products.

Of particular importance are optical metrology techniques for the determination of relative motion between different parts of an object, which may indicate degradation of its integrity or of part thereof, or of coatings on such objects including protective and optical coatings and paints, surface treatments, varnishes or lacquers.

Other forms of deformation in materials, including creep deformation and plastic deformation, require to be measured in both materials research and in engineering.

The measurement of deformation, strain, and motion on the nanometre to micrometer scale is also of importance in fields within the general field of nanotechnology. The following are examples.
Measurement of warpage, size, or dimensions.
Measurement of particle sizes, shapes and the distribution of particle sizes in nanotechnology.
Measurement of electromigration damage in metal wires and connections. This is of importance in the characterisation of electrically induced damage in metal wires and connections used for the interconnect of microelectronic integrated circuits and Microsystems.
Measurement of mechanical motion and actuation whether deformation, strain-free motion or actuation of a component.
Measurement of the coefficient of thermal expansion (CTE). For example, a 1 ppm/K error in the CTE value can overestimate the fatigue life of a solder joint by 46%.

Geometric Moiré effect and Moiré Interferometry (both collectively referred to as “Moiré”) and Electronic Speckle Pattern Interferometry (ESPI) are known optical methods for the measurement of deformation and strain on structures over a wide range of dimensions. A feature of these techniques is that they require a position reference on the sample surface from which any relative movements may be derived. In ESPI the inherent roughness of the surface provides a speckle pattern whose movement monitors changes in the strain state of the sample. In existing Moiré based methods a grating structure is deposited on the sample to provide the reference structure.

U.S. Pat. No. 6,134,013, “Optical ball grid array inspection system” describes a method for inspecting a 3D structure using collimated laser light. The technique relies on holographic or Moiré analysis of light scattered from the surface onto an array of optical detectors.

U.S. Pat. No. 6,078,396, “Non-contact deformation measurement”, describes a method of analysing plane deflections in materials under load by projecting a reference grating onto the sample and recording information relating to the individual colour channels of a colour camera, providing an imaginary (software) reference grating. This allows Moiré fringe analysis to be determined.

U.S. Pat. No. 5,898,486, “Portable Moiré interferometer and corresponding Moiré interferometric method”, describes a Moiré interferometer which is portable and shielded from the environment.

Electronic speckle pattern interferometry (ESPI) and variants on speckle interferometry and speckle photography have been reported since the early 1970s, for measuring in and out of plane object deformation by production of optical speckles when a coherent beam is scattered from a rough surface. Deformation of the sample changes the phase values of the speckles. Provided that the amount of deformation is small, so as not to cause decorrelation of the speckle pattern, the phase values of the speckles may be measured before and after the deformation, and can be related to the amount of deformation.

Electronic speckle pattern photography (ESPP) differs from the methods described above in that it is not truly interferometric. A single beam illuminates the object, which is imaged by a camera. Loading is applied and a second image is recorded. Small sub-images are then spatially cross-correlated between the deformed and undeformed images and the position of maximum correlation is used to measure the speckle displacement, from which the object displacement is calculated.

2-dimensional micro-deformation analysis by correlation (MDAC) is described in two prior art documents. DE19614896 describes a method of using the comparison of digital images to determine a displacement vector at a local point on the surface. DE19614897 describes a method of determining the field distribution of the displacement vector, and materials characteristic values which represent a function of the displacement, using the comparison of digital images.

The invention is directed towards providing a system and method for more versatile monitoring of deformation.

### SUMMARY OF THE INVENTION

According to the invention, there is provided a monitoring apparatus comprising:—
a light source for generating structured illumination;
a light sensor for sensing light reflected or scattered from a sample being monitored;
a controller having image processing functions for performing:
   (a) digital image correlation, and
   (b) Moiré effect processing, to determine sample deformation data; and
wherein the controller operates with a mode selected from a plurality of modes, the modes differing in terms of sample illumination and/or the image processing function used.

In one embodiment, the apparatus comprises actuators for moving optical components and the controller comprises functions for directing movement of the components according to mode of operation.

In another embodiment, the apparatus comprises a plurality of light sources and associated illumination paths, and the controller comprises functions for controlling activation of the paths.

In a further embodiment, the illumination paths comprise a common beam splitter for directing light from one or more paths through an objective onto a sample.

In one embodiment, the apparatus comprises a beam splitter for directing illumination towards a sample for a plurality of illumination paths, and for directing reflected or scattered light from a sample.

In another embodiment, a first illumination path comprises a light source, a collimating lens, a grating to impose structure, a focusing lens, and an objective lens.

In a further embodiment, the focusing lens is mounted to focus light onto a back focal plane of the objective lens.

In one embodiment, a second illumination path comprises a light source, a collimating lens, a focusing lens, and an objective lens.

In another embodiment, the second illumination path comprises the light source and optical components of the first illumination path and the controller comprises a function for moving away the grating to provide the second illumination path.

In a further embodiment, the apparatus comprises a sample mount comprising an actuator for moving a sample axially in an illumination path.

In one embodiment, the controller comprises an image correlation function for causing stepped axial movement of the sample mount close to focus and for compositing sub-images to provide a composite image.

In another embodiment, the controller directs use of the first illumination path for automatic focusing, and use of the first or the second illumination path for image correlation.

In a further embodiment, the first image path is used for image correlation and the controller directs stepped movement of the grating laterally across the illumination path, the steps sizes being a fraction of a grating period.

In one embodiment, the apparatus further comprises a third illumination path, said path comprising a coherent light source and optical components for directing off-axis transmission of light through the objective lens.

In another embodiment, the optical components focus the light onto the back focal plane of the objective lens.

In a further embodiment, the third illumination path comprises a laser light source.

In one embodiment, the controller comprises a function for performing Moiré image processing to determine deformation out of the plane of the sample using illumination from the first and third illumination paths.

In another embodiment, the controller directs the third illumination path to provide structured illumination.

In a further embodiment, the controller filters higher frequency projected fringes out of the captured images.

In one embodiment, the apparatus comprises an imaging path comprising an imaging lens, a wavelength filter, and an ambient light shield adjacent the sensor.

In another embodiment, the sensor comprises a CCD camera.

In a further embodiment, the apparatus further comprises a sample mount for controlled movement of a sample.

In one embodiment, the sample mount comprises means for applying mechanical, electrical, optical, or thermal stress conditions to a sample to cause deformation of the sample.

In another embodiment, the controller has an image correlation programmed mode of operation, using illumination from the first or second illumination paths.

In a further embodiment, the controller has an in-plane Moiré programmed mode using illumination from only the first illumination path.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:—

FIG. 1 is a diagrammatic overview of an apparatus of the invention;

FIG. 2 is a diagram of light impingement onto a sample;

FIG. 3 is a diagram of another apparatus of the invention;

FIGS. 4 and 5 are flow diagrams illustrating control steps of the apparatus controller; and

FIG. 6 is a diagram illustrating focusing using stacking of images.

### DETAILED DESCRIPTION OF THE EMBODIMENTS

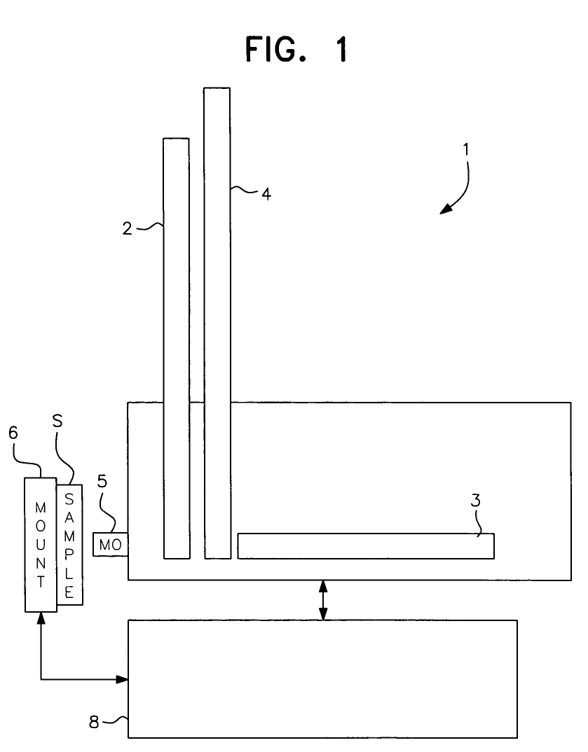

Referring to FIG. 1 a monitoring system 1 comprises the following.
2: an optical detector,
3: a first light source,
4: a second light source
5: an objective lens,
6: a sample mount, supporting a sample S,
8: a computer-based controller for initial inspection, selection of mode of operation for sample positioning, and for directing image capture and analysis.

The first light source 3 generates a light beam which is collinated through the objective lens 5 and is structured with a line pattern for in-plane (XY) Moiré analysis. This structured illumination extends across the width of the sample for full impingement across the sample.

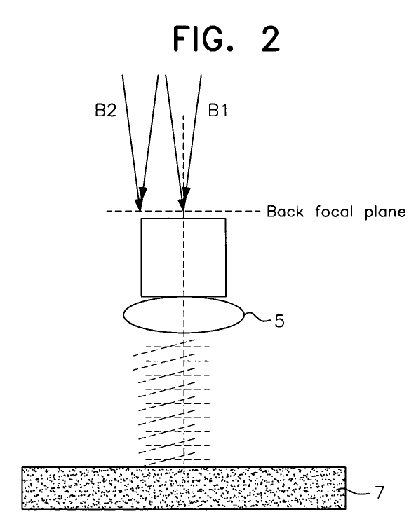

The second light source 4 comprises a laser to produce coherent light. This beam passes off-centre through the lens 5 so that it is deflected towards the optical axis to impinge on the sample at an angle to the normal. The second light beam is therefore suitable for out-of-plane Moiré analysis. FIG. 2 is an illustration of the beams and how they pass through the lens 5 and impinge onto the sample. B1 is produced by an LED in the first light source 3 and is focussed onto the back focal plane of the objective 5 on-axis through the centre of the objective. B2 is produced by the laser of the second light source 4 and is focused onto the back focal plane of the objective at a distance from the centre. This allows the coherent laser beam to exit the objective at an angle to the normal.

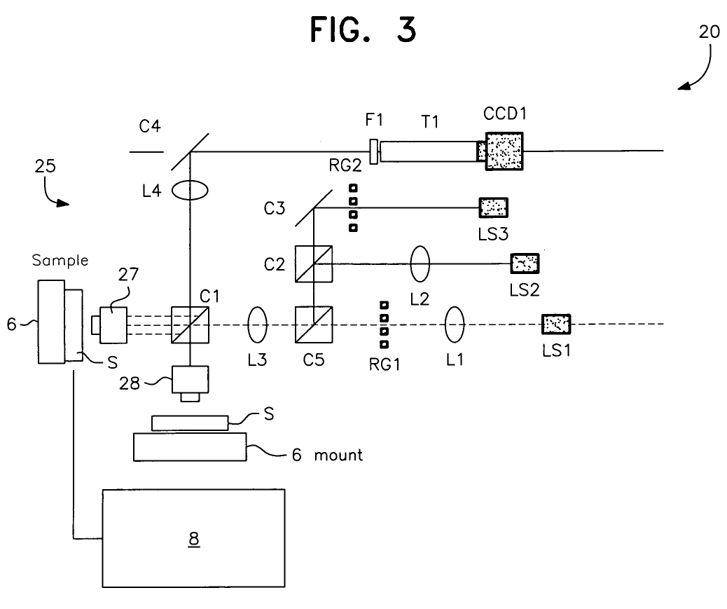

Referring to FIG. 3 a monitoring apparatus 20 comprises two orthogonal mounts 6 supporting samples S, and a computer controller 8. However, in this embodiment there are first, second, and third light sources LS1, LS2, and LS3 and an optical detector CCD camera CCD1. The light source LS1 and its following optics for its illumination path are equivalent to the source 3 of the apparatus 1, and the source LS3 and its illumination path are equivalent to the source 4 of the apparatus 1.

The illumination path from the source LS1 comprises:
a lens L1 for collimating the light,
a Ronchi Grating RG1,
a beam splitter C5,
a lens L3 for focusing,
a beam splitter C1, and
the objective lens' 27 or 28, depending on control of the splitter C1.

Light from the source LS2 passes through a collimating lens L2 and a beam splitter C2 followed by C5-L3-C1-27/28. Light from the source LS3 passes through a Ronchi Grating RG2 and a mirror C3 followed by C2-C5-L3-C1-27/28.

Reflected light from a sample S is directed to the camera CCD1 (charge-coupled device) via the objective lens 27/28, the beam splitter C1, an imaging lens L4, a beamsteering mirror C4, a coloured glass wavelength filter F1, and a tube T1 for blocking ambient light. The light shield T1 includes a baffle device consisting of a series of opaque panels to trap stray light entering the enclosure through an aperture.

The light sources LS1 and LS3 generate uniform light from which fringes are generated by the gratings RG1 and RG2. The second light source LS2 provides a non structured illumination source for uniform sample illumination.

The apparatus can, by suitable control of the three sources, optics, and the detector, perform:
in-plane Moiré analysis,
out-of-plane Moiré analysis,
image correlation (MDAC).

In this specification, “in-plane” means the X-Y plane of a sample, and “out-of-plane” means the Z-direction normal to the X-Y plane.

The computer controller 8 controls the devices by way of electromechanical drives to move some in and out of the relevant optical path and to change source intensities/wavelengths to produce the desired bright/dark patterns. The controller 8 can select the sample position from the two shown in FIG. 3.

In both the apparatus' 1 and 20 the controller directs the first light source to produce a periodically varying intensity profile B1 laterally across the sample. This light source is used in modes of operation in which image recording is performed using periodically varying illumination, and in modes in which Moiré effect measurements or imaging are performed.

The second light source (only in the apparatus 20) produces an approximately uniform intensity profile laterally across the beam at the sample. It is used in a mode in which image recording is performed using approximately uniform intensity illumination which is not periodically varying in intensity across the target material or component. This source is used for image correlation measurements.

The third light source LS3 (and its equivalent source 4 in the apparatus 1) is used in the case of the Moiré effect out-of-plane mode to project a second periodically varying illumination pattern onto the target material or component. This is the off-centre laser B2 shown in FIG. 2.

In the sources LS1 and LS3 there is a phase shifting operated by the controller for translating the pattern of the structured illumination laterally (i.e. orthogonally to the beam propagation direction) and for varying fractions of its periodic repeating pattern where the structure has such a pattern. This operates by moving the grating laterally by a fraction of a single period of the grating. In one example, the grating period is 1/600 mm, and the translation is typically in the range of 20% to 60% of the period.

The microscopic objectives 27 or 28 are infinity-corrected objectives which are aligned relative to the optical axes such that the alignment is telecentric and the workpiece surface placed near the focus of the objective is illuminated in the manner of Kohler illumination to a high degree of uniformity of intensity over the illumination region.

The optical components of the apparatus are mounted on an optical mounting plate, housed in a single compact housing. The optical mounting plate comprises a series of parallel slots for the mounting of optical component mounts by means of bolts of different sizes. The resulting compactness is not only important for ease of use but improves system stability and hence measurement precision. The optical mounting plate may be equipped with handles for ease of insertion in an instrument housing, in preferred embodiments of the invention.

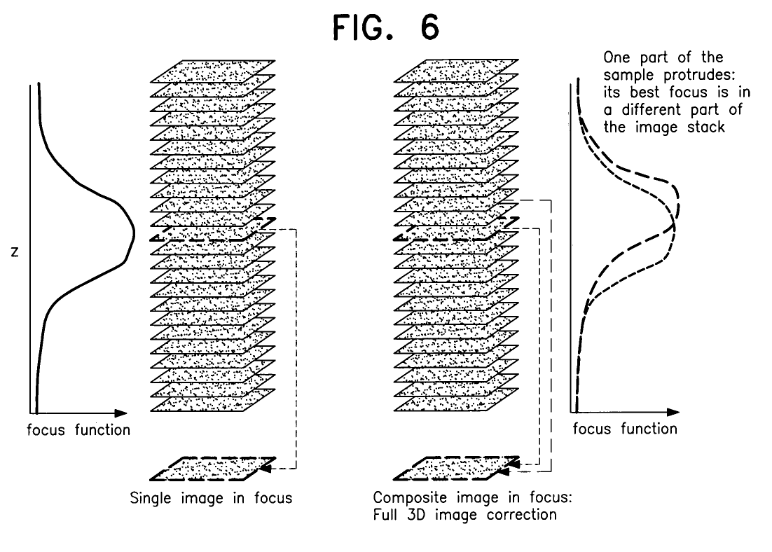

The sample position may be altered with respect to the optical part of the apparatus and in one or more dimensions by means of the electromechanical mount 6 which is computer controlled. The sample mount 6 may include a thermal device for increasing the temperature of the sample and/or a cryostatic means for decreasing the temperature of the sample. Also, it may comprise a circuit for delivering electrical power to the sample, which may change the temperature of different regions of the sample, or may cause parts of the sample to move. The mount may also comprise a mechanical system for applying a mechanical deformation to the sample; a thermal device to cause solder or other metal alloys forming part of a sample to become liquid and flow; a liquid or gas container; a colour-changing means which changes colour in response to some property or condition of a sample or its environment. The controller 8 is programmed to automatically capture the sample condition status data and time stamps. The mount 6 comprises a thermoelectric element and a chuck bonded to it. The chuck comprises a resistive thermometer. The sample is mounted in good thermal contact with the chuck. Heat is transferred or extracted through the chuck by applying suitable currents and voltages to the thermoelectric device. The heating/cooling is controlled by a controller function which specifies the starting and finishing temperature of each step and the time at which the chuck must remain at a steady state temperature before images are recorded. A typical program involves:
(a) heating or cooling to an initial reference temperature, performing autofocus and image stacking as described below with reference to FIG. 6 to acquire an image (single or composite), and
(b) repeating this process at a higher or lower temperature, and step (b) repeating again for a desired number of steps.

The controller has a frame grabber for acquiring the images. Temperature is captured via an A/D interface to the chuck resistive thermometer.

In one embodiment, the apparatus is portable and capable of alignment to the sample in situ if it is inconvenient to move the sample.

In operation, light from the semiconductor light emitting diode LS1 is collimated by the lens L1, such that the beam subsequently illuminates the Ronchi Grating RG1 at the focus of L4, and then passes through the objective 27. The function of the objective 27 is to create the spectrum of the Ronchi Grating RG1 and to remove undesirable orders from the beam, creating a periodically varying (which may be sinusoidally varying) intensity profile laterally across the beam at the sample.

The beamsplitter C5 allows combinations of the three possible illumination paths. The beamsplitter C1 allows a single path through the objective 27 or 28 to be used for both illumination and imaging.

LS2 provides uniform, non-structured illumination across the sample, suitable for image correlation processing by the controller 8.

The third source LS3 comprises a laser source which has been expanded to its desired beam width. It passes through the Ronchi Grating (RG2) which has been placed at the focus of the lens L3. This beam is directed along the path of RG2, C3, C2, C5, C1, and the objective 27/28 onto the sample.

Each objective 27 and 28 is an infinity corrected microscopic objective, aligned relative to the optical axes the lenses and such that the alignment with L1 and L4 is telecentric and the workpiece surface, placed near the focus of the microscopic objective is illuminated in the manner of Kohler illumination to a high degree of uniformity of intensity over the illuminated region.

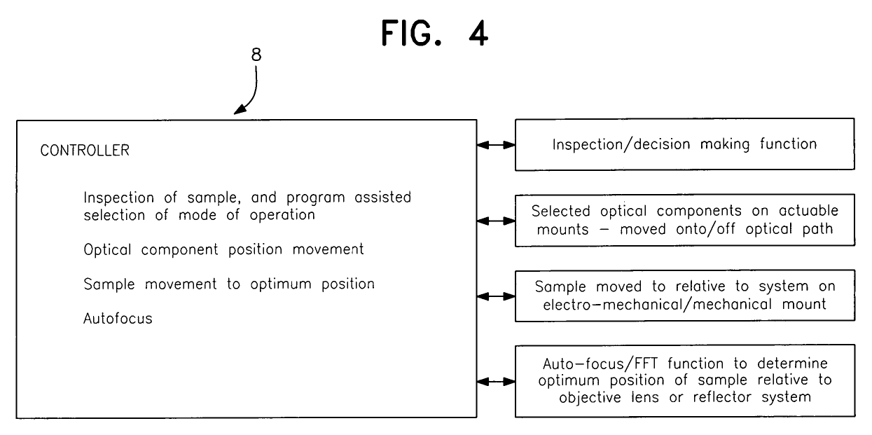

Operation of the controller 8 of the apparatus of FIGS. 1 and 3 is illustrated at a high level in. FIG. 4. The major functions are inspection/decision making functions, actuation of optical components, sample movement, and automatic focusing. The apparatus has the advantage of enabling flexibility of operation and is capable of operation in any of four modes, for the purposes of deformation and strain measurement or for the extraction of other information during processing of the image or images after their recording. These modes are:
Mode 1. Image recording under conditions of structured or unstructured illumination, including the recording of a set of multiple images under different sample conditions, and including performance of image correlation (MDAC, micro-deformation analysis by correlation of images) using periodic illumination.
Mode 2. Recording of a set or stack of images using approximately uniform illumination and as a function of moving the position of the sample surface relative to the microscopic objective through the focal plane of the objective or otherwise.
Mode 3. In-plane geometric Moiré effect imaging
Mode 4. Out-of-plane geometric Moiré effect imaging

In this specification, the use of the term “Moiré effect”, when not qualified by either the term “geometric” or “interferometry/interferometric” can be taken to mean either type of Moiré effect.

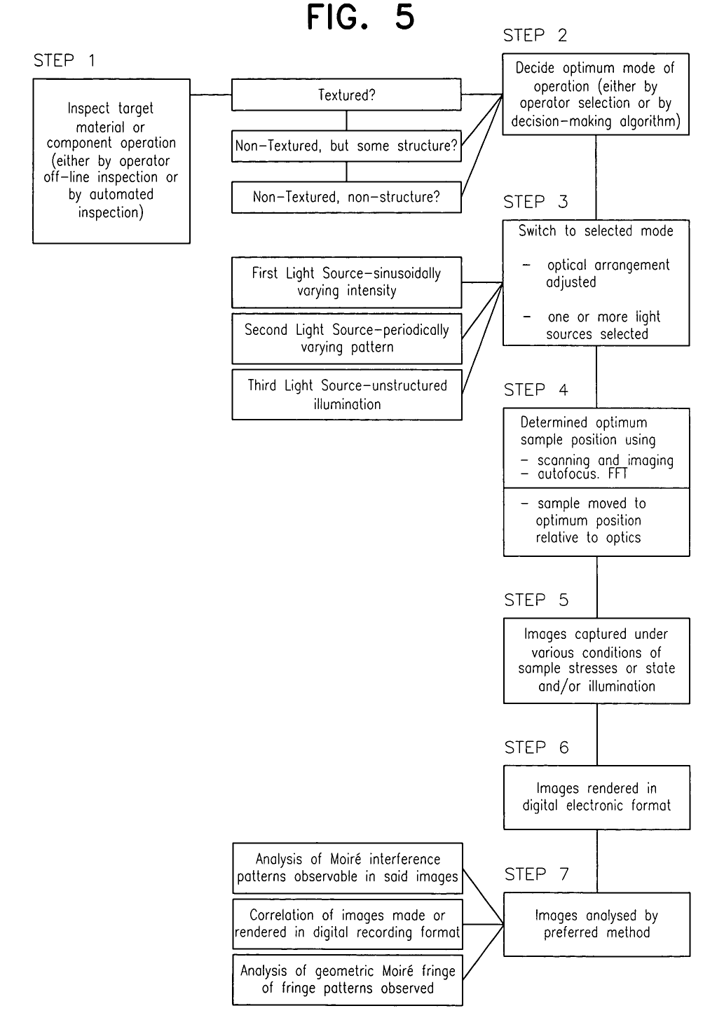

The mode of operation most appropriate to the properties of the target, and requiring minimum sample preparation can be selected. Referring to FIG. 5 the overall operation of the apparatus, with mode selection, is illustrated.

Step 1. The sample is inspected. A preliminary inspection is performed to determine the sample properties. The target material or component may have a periodic or other structure which has a different optical appearance at different parts of its surface, or may have one or more of its surfaces polished or round or roughened.

The controller 8 has image processing functions to determine whether or not sufficient texture exists for the implementation of a digital image correlation method on a material workpiece inspected by it. These functions process captured images to determine the extent of texture by analysing the variations of grey scale levels within a number of sub-images. Where there is very little texture, such as a highly polished sample, a structured illumination source will be used.

Samples with inherent texture or optical contrast in the image field of view, which may be due to their structure or their composition of different materials, are suitable for inspection in the Modes 1 and 2. Samples which lack inherent texture, but which may possess a grating structure, or to which a grating structure may be applied if desired are preferably measured using Moiré effect Modes 3 or 4.

Steps 2 & 3. Optimum mode of operation of the apparatus is selected. It is possible to manually or programmably select the optimum mode of operation of the apparatus.

The control of the motion of the sample and of optical components confers flexibility allowing the mode of operation to be programmed into the system according to the surface quality preparation and texture. This also allows a series of multiple images to be made of the sample at different distances from the microscopic objective, as the sample is moved through the optimum focus position relative to the microscopic objective. It also allows a series of multiple images to be made of the sample under the same sample conditions and with the sample either always at the focus of the microscopic objective or at a constant distance from it, in order to build up an image of the sample which is larger than the field of view of the microscopic objective.

Step 4. Determination of optimum sample position and movement of the sample relative to the optics as required. An autofocus routine based on FFT of the image and analysis of the frequency distribution present in the image in order to determine the best focused image is implemented. Also, a multiple stacked imaging method can be implemented where a through focus series of images is acquired of a sample at different distances from the microscope objective and in which the central image in the series is well focused.

Step 5. Images are made of the sample. These images are recorded using the same optical illumination and recording imaging mode of the apparatus, but under different sample conditions. For example, the apparatus may be used to acquire images of a sample at different temperatures or under different mechanically or otherwise induced local deformations such that deformations may be determined by any or all of the following methods described in subsequent steps. The apparatus may be used to acquire images of a sample at different distances from the focus of the microscopic objective.

Step 6. Images are rendered in digital electronic format. Images recorded from different areas of the sample may be combined to render a larger image. Parts of images recorded at different distances of the sample from the microscopic objective may be selectively combined to render a single image of all points of which are in focus with the microscopic objective.

Step 7. The determination of deformation, strain, thermal expansion, is by the comparison of two or more of the images recorded, or subsequently rendered at step 6, by any of the following methods:
(i) correlation of the images made or rendered in a digital recording format.
(ii) analysis of geometric Moiré fringes or fringe patterns observable in said images.
(iii) analysis of Moiré interference patterns observable in said images.
(iv) compositing of data extracted from said images in order to produce a composite image.

More often, the Moiré effect is geometric rather than interferometric. However, some modes use an interferometric Moiré effect because of its greater sensitivity. For analysis by either the geometric Moiré effect or by Moiré interferometry, depending on properties of the illumination, Moiré fringes are produced at the sample plane after stress induced in-plane deformation at the sample plane. In-plane deformation may be determined from calculation of the displacement of the Moiré fringes in subsequent images from those in a first reference image.

For automatic focusing, the controller 8 implements an autofocus method based on a Fourier transform of the image and analysis of the frequency distribution present in the image in order to determine the nearest focus image. A software function performs a Fast Fourier Transform of the real-time image of the workpiece yielding an analysis of the frequencies present in the digital image. The workpiece is in best focus when the image is sharpest, which in mathematical terms is when the highest proportion of high frequencies are present in the digital image.

The controller 8 also controls a heat filtering glass plate, or an opaque shutter, interposed between the workpiece and the objective or between the objective and other elements of the optical path, to prevent excessive heat from a thermal stressing device or from a thermally stressed workpiece from reaching the optical components. To achieve this the controller 8 controls a glass filter plate mounted on an actuation device. Where the sample is viewed from the side, most of the heat will be convected upwards rather than radiating sideways to the optical assembly.

The following describes in more detail in simple terms how the apparatus (FIG. 3) operates for each of Modes 1-4.

Mode 1

LS1 or LS2 Activated, Image Correlation.

When operated in Mode 1, the apparatus makes use of the inherent texture or image contrast present on the surface of most engineering and micro-engineering materials and structure by imaging the texture as a function of the applied stress. Digital/Image correlation of blocks of pixels in these images is performed to determine the motion of local regions by means of tracking motion of the local image details associated with its texture.

After image acquisition, controller functions calculate the deformation due to stress by finding the position of maximum cross correlation between undeformed and deformed regions of the image, known as subimages. A deformation map is then built up across the entire field of view. In one option for this mode LS1 is used for auto focusing, followed by LS2 for the image correlation.

The use of structured illumination (LS1) is to assist in the autofocus routine. The presence of the fringes on the sample being measured increases the sensitivity of the autofocus routine to smaller changes in focus of the image.

In another option, structured illumination from LS1 is used for both auto-focus and image correlation. LS1 is used for image correlation particularly where the sample does not have much surface texture. RG1 is stepped laterally across the beam by a fraction of a period, and an image is acquired at each step for phase-step Moiré. Phase-step Moiré increases the displacement sensitivity per Moiré fringe.

Mode 2

LS1 or LS2, Image Correlation.

In this mode a series of images is recorded when the sample is at different distances from the microscopic objective, which are near the focus position. The entire part of the sample within the field of view need not be in focus in any image. Different in-focus subimages of the images at different sample positions are combined to give a composite image which is made up of a series of in-focus subimages. This technique is useful where a sample is not flat or is tilted. FIG. 6 shows the manner in which a stack of images is made through the region of focus of the optical system, and the way in which the image in focus is selected or composited. The focus function is important for the compositing process, and can be evaluated for every part of an image. The 3D stack of images is acquired and processed by a Fast Fourier Transform function to auto-select the best focus regions of different stack images and render them as composite image in focus.

Mode 3

LS1 Only, In-Plane Moiré.

The sample has a colour intensity grating (as opposed to a phase grating) deposited on its surface. The combination of fringes which have been projected onto the sample through the objective and those deposited grating lines produce Moiré fringes when the sample deforms. Images of the sample are captured before and after application of an applied stress. In-plane deformation is determined from calculation of the displacement of the Moiré fringes in subsequent images from those in a first reference image after digital filtering of the image to remove the higher frequency orders of the projection fringes and grating lines. In one Moiré effect mode of the invention, the sample and illumination optics are adjusted such that no Moiré fringes are visible in the image prior to stressing of the sample.

Mode 4

LS1 and LS3, Out-of-Plane Moiré.

This mode does not require the use of a grating structure or periodic structure on the sample surface. Using LS3 a second periodically varying illumination pattern of the same frequency as that produced by LS1 is projected onto the sample as shown in FIG. 2. In other words, the apparatus allows out-of-plane strain determination by the Moiré effect method using a combination of normal fringe projection onto the sample combined with off-normal axis projection through a microscopic objective. When the sample under test deforms due to stress in the out-of-plane direction the combination of the on axis and off axis fringes produce Moiré fringes which are related to the amount of deformation. The higher frequency projected fringes are filtered out of the image.

The out of plane displacement, W is given by

$$W = {gN}_{Z} = \frac{1}{f} {N}_{Z}$$

where g and f are the projected grating pitch and frequency and N is the fringe order in the out of plane measurement.
Additional Aspects of Operation of Apparatus 20

Modes 1 or 2 may be performed at multiple successively overlapping sample areas. This is achieved by control of the sample mount 6. The images may be composited into a larger high-resolution image for image correlation to determine deformation.

The controller 8 may also be used to measure the co-efficient of thermal expansion of a material, because thermal expansion is a deformation of the material.

The apparatus may be used to examine a localised microscopic field of view on a microscopic scale or on a larger area scale by an appropriate choice of illumination and imaging optics and their control. If the area scale becomes so large that the resolution is too large to determine micro-deformation, the MDAC technique is implemented as deformation analysis by correlation (DAC).

The apparatus allows deformation due to many different types of stress to be measured. It allows the sample to be inspected during transient thermal processes such as during solder reflow processes or metal alloying or creep. The apparatus also allows a strain image to be recorded on applying electrical power or signals to an electrical or electronic or micro-electro-mechanical system to induce the stresses and deformations inherent to the normal functioning of such a device.

The apparatus may be used to the strain or deformation measurements sufficiently fast for real time output. This may be during the performance of a process on the material or component. Examples are measuring the changing deformation or strain in a microelectronic, optoelectronic or microsystem component or device, whether or not packaged, during a process to attach or bond said component or device to another material, component, device or system.

The apparatus may be used to determine strain or deformation of objects which are of a fragile nature. Examples are objects such as historical artefacts, archaeological structures, murals, and historical structures. The determination of damaged regions of physically existing works of art including paintings, mural images, fresco images, ceiling images, floor images, mosaic images and patterns, and archaeological artefacts and structures may be performed.

The invention is not limited to the embodiments described but may be varied in construction and detail. For example, the light sources LS1 and LS2 may comprise instead emitters directing light into a fibre bundle, the outputs of which are directed on the relevant light paths. Also, there may be only one light path corresponding to both LS1 and LS2, in which the grating is movable in and out of the path for conversion.

1. A monitoring apparatus comprising:—
a light source for generating structured illumination;
a light sensor for sensing light reflected or scattered from a sample being monitored;
a controller having image processing functions for performing:
(a) digital image correlation, and
(b) Moiré effect processing,
to determine sample deformation data; and
wherein the controller operates with a mode selected from a plurality of modes, the modes differing in terms of sample illumination and/or the image processing function used.

2. A monitoring apparatus as claimed in claim 1, wherein the apparatus comprises actuators for moving optical components and the controller comprises functions for directing movement of the components according to mode of operation.

3. A monitoring apparatus as claimed in claim 1, wherein the apparatus comprises actuators for moving optical components and the controller comprises functions for directing movement of the components according to mode of operation; and wherein the apparatus comprises a plurality of light sources and associated illumination paths, and the controller comprises functions for controlling activation of the paths.

4. A monitoring apparatus as claimed in claim 3, wherein the illumination paths comprise a common beam splitter for directing light from one or more paths through an objective onto a sample.

5. A monitoring apparatus as claimed in claim 3, wherein the illumination paths comprise a common beam splitter for directing light from one or more paths through an objective onto a sample; and wherein the apparatus comprises a beam splitter for directing illumination towards a sample for a plurality of illumination paths, and for directing reflected or scattered light from a sample.

6. A monitoring apparatus as claimed in claim 3, wherein a first illumination path comprises a light source, a collimating lens, a grating to impose structure, a focusing lens, and an objective lens.

7. A monitoring apparatus as claimed in claim 3, wherein a first illumination path comprises a light source, a collimating lens, a grating to impose structure, a focusing lens, and an objective lens; and wherein the focusing lens is mounted to focus light onto a back focal plane of the objective lens.

8. A monitoring apparatus as claimed in claim 3, wherein a first illumination path comprises a light source, a collimating lens, a grating to impose structure, a focusing lens, and an objective lens; and wherein a second illumination path comprises a light source, a collimating lens, a focusing lens, and an objective lens.

9. A monitoring apparatus as claimed in claim 8, wherein the second illumination path comprises the light source and optical components of the first illumination path and the controller comprises a function for moving away the grating to provide the second illumination path.

10. A monitoring apparatus as claimed in claim 1, wherein the apparatus comprises a sample mount comprising an actuator for moving a sample axially in an illumination path.

11. A monitoring apparatus as claimed in claim 10, wherein the controller comprises an image correlation function for causing stepped axial movement of the sample mount close to focus and for compositing sub-images to provide a composite image.

12. A monitoring apparatus as claimed in claim 8, wherein the controller directs use of the first illumination path for automatic focusing, and use of the first or the second illumination path for image correlation.

13. A monitoring apparatus as claimed in claim 12, wherein the first image path is used for image correlation and the controller directs stepped movement of the grating laterally across the illumination path, the steps sizes being a fraction of a grating period.

14. A monitoring apparatus as claimed in claim 3, wherein the apparatus further comprises a third illumination path, said path comprising a coherent light source and optical components for directing off-axis transmission of light through the objective lens.

15. A monitoring apparatus as claimed in claim 14, wherein the optical components focus the light onto the back focal plane of the objective lens.

16. A monitoring apparatus as claimed in claim 14, wherein the third illumination path comprises a laser light source.

17. A monitoring apparatus as claimed in claim 14, wherein the controller comprises a function for performing Moiré image processing to determine deformation out of the plane of the sample using illumination from the first and third illumination paths.

18. A monitoring apparatus as claimed in claim 17, wherein the controller directs the third illumination path to provide structured illumination.

19. A monitoring apparatus as claimed in claim 17, wherein the controller filters higher frequency projected fringes out of the captured images.

20. A monitoring apparatus as claimed in claim 1, wherein the apparatus comprises an imaging path comprising an imaging lens, a wavelength filter, and an ambient light shield adjacent the sensor.

21. A monitoring apparatus as claimed in claim 1, wherein the sensor comprises a CCD camera.

22. A monitoring apparatus as claimed in claim 1, wherein the apparatus further comprises a sample mount for controlled movement of a sample.

23. A monitoring apparatus as claimed in claim 22, wherein the sample mount comprises means for applying mechanical, electrical, optical, or thermal stress conditions to a sample to cause deformation of the sample.

24. A monitoring apparatus as claimed in claim 14, wherein the controller has an image correlation programmed mode of operation, using illumination from the first or second illumination paths.

25. A monitoring apparatus as claimed in claim 14, wherein the controller has an in-plane Moiré programmed mode using illumination from only the first illumination path.
